(19) United States
(12) Patent Application Publication
(10) Pub. No.: US 2026/0241814 A1
(43) Pub. Date: Aug. 20, 2026

(54) ELECTRIC TRUCK WITH ON-BOARD CHARGER FOR ENERGY DISTRIBUTION NETWORK MAINTENANCE SERVICES

(71) Applicant: ELEKTRO REDES S/A, Campinas (BR)

(72) Inventors: Amanda Dias Cortez, Campinas (BR); Eduardo Casarin, Campinas (BR); Antonio Palmiro Fujita, Campinas (BR); Signie Laureano Franca Santos, Curitiba (BR); Ana Paula Oening, Curitiba (BR); Victor Salvino Borges, Curitiba (BR); Edemir Luiz Kowalski, Curitiba (BR)

(21) Appl. No.: 18/870,909

(22) PCT Filed: May 24, 2023
(86) PCT No.: PCT/BR2023/050158

§ 371 Date: Dec. 2, 2024

(30) Foreign Application Priority Data
May 30, 2022 (BR) 1020220105170

(51) Int. Cl. B60L 53/20; B60L 53/16; B60L 53/18

(52) U.S. Cl. CPC B60L 53/20; B60L 53/16; B60L 53/18; B60L 2200/36

(57) ABSTRACT

An electric truck for power distribution network maintenance services has an on-board charger. The electric truck with the on-board charger has its own, specific electro-electronic structure. The structure includes the on-board charger, a step-up transformer, electrical protection elements and electrical connection elements in the distribution network, each on-board the electrical truck. The on-board charger optimizes completely opportunity charging of the electric truck by the low-voltage electric power distribution network. The on-board charging provides excellent charging capacity and greater autonomy for the truck.

This invention patent relates to automotive vehicles in general, more specifically to an electric truck with an onboard charger for maintenance services of the power distribution network which, according to its general characteristics, has as its basic principle to provide the formation of an electric truck with an onboard charger in its own specific structure of the electro-electronic type and based on a charger, a transformer, electrical protection elements and electrical connection elements in the distribution network, both embedded in the body of an electric-powered cargo vehicle.

This structuring aims to enable in an extremely practical, safe and precise manner a complete optimization of the procedures for recharging electric-powered cargo vehicles directly through the low-voltage power distribution network itself, combined with excellent recharging capacity and greater autonomy for electric-powered cargo vehicles and based on an electric truck with an onboard charger of great resistance, safety and versatility.

With a specific design and format and easy access for better adaptation and safety of users, practical handling and functionality, affordable costs and, due to its general characteristics and dimensions, easily adaptable to a wide range of cargo vehicles, low voltage electrical power distribution networks, users and locations in general, regardless of the characteristics they may present.

The main motivation for this concept was the primary objective of providing significant advances in innovation, research and development of solutions with high technological content combined between the electrical sector and the automotive industry, in two areas that are global trends, such as electromobility and smart grids.

Today, there is a growing increase in the consumption of electrical energy, at the same time as there is an increasing search for efficient means of reducing environmental and economic costs in the processes of generation, transmission and distribution of electrical energy. From the perspective of transport infrastructure, the idea of urban mobility with zero pollutant emissions has been gaining ground, especially the solution presented by the use of plug-in electric vehicles, including plug-in hybrid electric vehicles and battery electric vehicles, which present great benefits and challenges, as they are capable of interacting with distribution networks with the advent of smart grid-type electrical networks.

In this sense, with the aim of contributing to the objectives proposed in the theme of electromobility in the country, this patent proposes an electric truck with the necessary implementations to perform maintenance services in electricity distribution networks, which includes integration of a hydraulic arm and aerial basket.

Currently, electrically propelled cargo vehicles-electric trucks, when there is a routine need to recharge their batteries embedded in their bodies and which in some cases are responsible for powering their propulsion systems, as well as their onboard equipment such as aerial baskets and mowers, among others, are forced to look for fixed charging points widely known as electric charging stations.

However, although these fixed charging points known as electric charging stations are highly efficient and widely used, they are often located many kilometers away from the point where electric-powered cargo vehicles are positioned and, mainly, where they perform their routine tasks, such as maintaining electricity distribution networks. In some cases, they are not even within a reasonable or acceptable distance for recharging.

It is worth noting that electric-powered cargo vehicles, as well as all of their onboard electrically powered equipment, have a low energy storage capacity for the prolonged and safe execution of their basic operating procedures, such as moving and activating their equipment. In most cases, charging hours are minimal and insufficient.

Therefore, these electric-powered cargo vehicles constantly need, and most often for short periods, to have their batteries recharged to ensure sufficient autonomy during the provision of services to be performed, such as maintenance of electricity distribution networks.

In addition to these operational drawbacks of electrically powered cargo vehicles—electric trucks, we can mention: equipment of large dimensions and varied formats; lack of specific equipment, being based on equipment adaptations; use of several pieces of equipment interconnected between s1; need for constant interconnection to fixed charging bases; need for several communication and power cables; lack of any type of ergonomics; low storage and electrical recharging capacity; and complex and time-consuming handling capacity.

Thus, it has become essential for companies that use electrically powered cargo vehicles, especially those that perform routine maintenance of electricity distribution networks in remote regions, to structure a versatile, practical, safe and precise system that allows the connection of opportunity recharging of electrically powered cargo vehicles to the concessionaire's own distribution network based on on-board equipment.

Thus, the invention patent in question is characterized by bringing together components and processes in a differentiated design, which will meet the various requirements that the nature of use demands, that is, allowing opportunity recharging of electric-powered cargo vehicles in the electricity distribution network itself. This design guarantees an electric truck with an on-board charger that is highly efficient, functional, resistant, durable, safe, versatile, precise and economical due to the excellent technical qualities added, which provides advantages and improvements in routine recharging procedures in electric-powered cargo vehicles in the most diverse locations and whose general characteristics differ from other forms and models widely known in the current state of the art.

In a broad analysis of the literature with the aim of establishing the current state of the art regarding systems and/or devices for recharging electric-powered cargo vehicles-electric trucks, more specifically electric-powered cargo vehicles with on-board chargers for maintenance services of energy distribution networks that allow the connection of opportunity recharges in the distribution network of the concessionaire itself, the object of this invention patent, no documents relevant to the state of the art were described that relate to the specific structuring of the claimed object.

In this conception, the present invention patent consists of the use of a modern, efficient, safe and functional electric truck with on-board charger for maintenance services of the energy distribution network formed by a set of correctly incorporated electro-electronic and vehicular solutions, composing an electric truck with on-board charger with its own characteristics, which incorporates its own and specific structure of the electro-electronic type containing integrated and symmetrically arranged among themselves and embedded in the body of an electric-powered automotive cargo vehicle an on-board charger with the primary function of fully/partially recharging the electric-powered automotive cargo vehicle directly from the low-voltage electricity distribution network; a step-up transformer with the primary function of adapting the voltage level required for the on-board charger; electrical protection elements with the primary function of protecting the assembly against electrical overloads; and electrical connection elements with the primary function of connecting the assembly to the low-voltage electrical power distribution network, in order to enable the formation of a single, complete and safe assembly, whose internal and external shapes and arrangements allow perfect adaptation to a wide range of electrically propelled cargo vehicles, being specially designed for these purposes with its own geometry.

More specifically, the general design of this electric truck with on-board charger for maintenance services of the power distribution network, which is the subject of this invention patent, is based entirely on its simple and robust structure with a minimum of components required and extremely simplified, safe and optimized operation, combined with very practical manufacturing and maintenance procedures, in order to generate a practical and efficient electric truck with on-board charger capable of enabling greater autonomy for electric-powered cargo vehicles-electric truck through the installation of an intelligent set for recharging management and a safe and efficient system to allow the connection of opportunity recharging of the electric-powered cargo vehicle to the low-voltage power distribution network itself, based on an on-board charger, a power transformer, electrical protection elements and elements for connection to the low-voltage distribution network, both embedded in the body of an electric-powered cargo vehicle.

Opportunity charging on the electricity distribution network itself has the primary purpose of enabling the free circulation of cargo vehicles, as well as the performance of various maintenance activities on the electricity distribution network without relying exclusively on fixed charging points widely known as electric charging stations.

In this way, these opportunity charging stations make it possible to greatly increase the autonomy of cargo vehicles during the provision of maintenance services on the electricity distribution networks, in addition to charging in regions that do not have fixed electric charging stations—expanding the locations of operation, or even responding to emergency situations.

In this line, the present electric truck with on-board charger is based on the application of components and processes in a differentiated design, without, however, reaching a high degree of sophistication and complexity, making it possible to solve some of the main drawbacks of other forms and models known by the current state of the art and used in the procedures for recharging types of locations, which are located in a work range in which the difficulties of use and application, low efficiency and performance and the forms and/or models are either based on simple adaptations, thus being highly unsafe, highly deteriorating and fragile, with little durability and resistance, low versatility, high imprecision, laborious to apply, no ergonomics, low yield and negligible performance, or are large, being of very high cost, high volume and overall weight, little flexibility, complex handling, high maintenance, great waste of time, complex manufacturing, low versatility and low performance.

The objectives, advantages and other important features of the invention patent in question may be more easily understood when read in conjunction with the attached figures, as briefly described below.

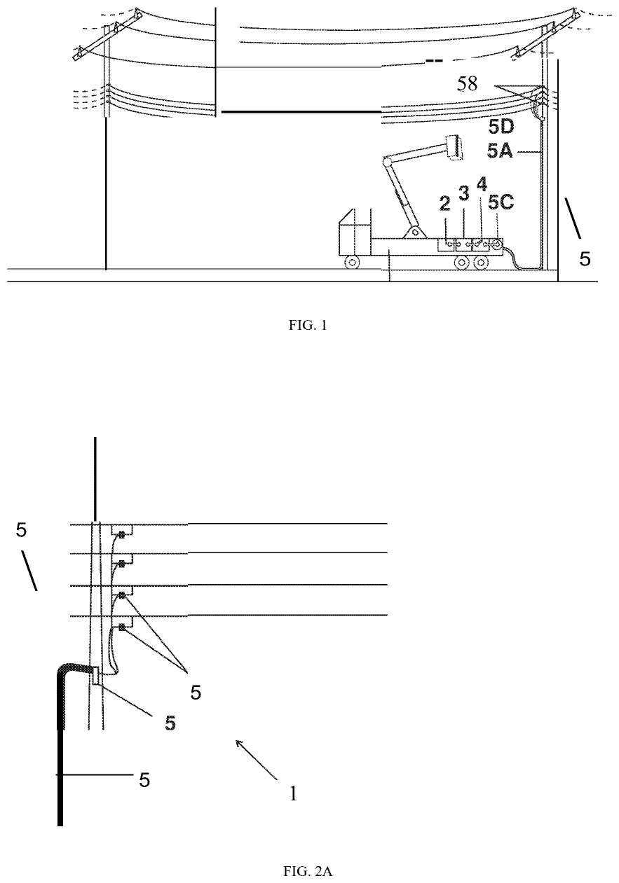

FIG. 1 represents a schematic view of the electric truck with on-board charger for maintenance services of a power distribution network interconnected to a low-voltage power distribution network.

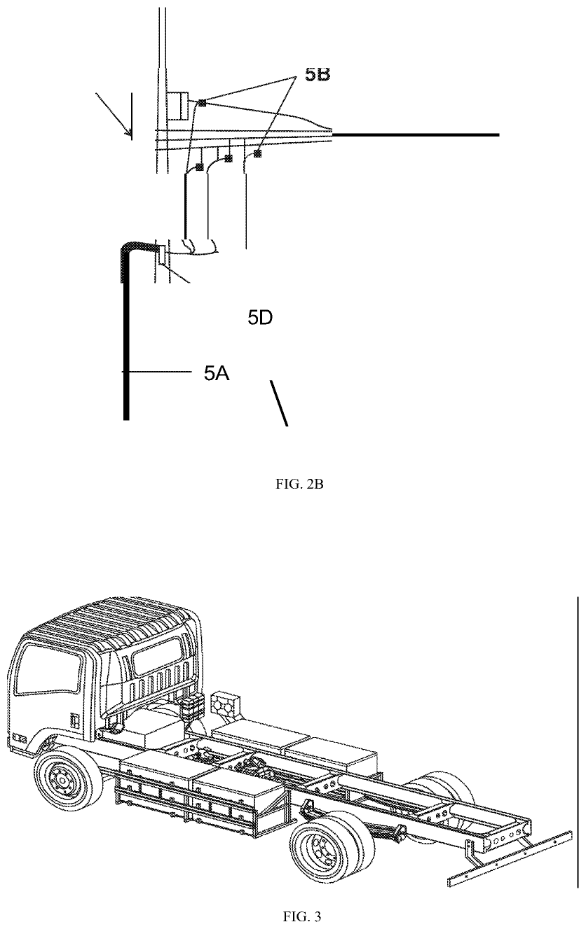

FIG. 2A represents a schematic view of the connection of the four-core cable constituting the electrical connection elements of the electric truck with on-board charger to the low-voltage power distribution network in the bare configuration.

FIG. 2B represents a schematic view of the connection of the four-core cable constituting the electrical connection elements of the electric truck with on-board charger to the low-voltage power distribution network in the multiplexed configuration.

FIG. 3A represents a rear perspective view of the electric truck with on-board charger for maintenance services of a power distribution network.

As can be inferred from the attached figures that illustrate and form part of this descriptive report of the invention patent for “Electric Truck with On-Board Charger for Power Distribution Network Maintenance Services”, Figure IA presents the same in general terms, comprising an electric truck with on-board charger (1) complete and with its own characteristics, incorporating its own specific electro-electronic structure, highly durable and resistant and containing, perfectly interconnected and arranged on-board the body of an electric-powered cargo vehicle, an on-board charger (2) arranged interconnected to the battery bank of the electric truck with on-board charger (1) and consisting of a gun, supply voltage of 380 Vac, frequency of 60 Hz, nominal current of 63 A, nominal recharging power of 40 kW, and European CCS charger standard, fully or partially recharging the electric truck with on-board charger (1) directly on the low-voltage power distribution network; a step-up transformer (3) arranged interconnected to the on-board charger (2) and consisting of a dry transformer with three phases, primary voltage at 220 V, secondary voltage at 380 V and power of 50 KVA, adapting to the voltage level required for the on-board charger (2), since the secondary of the distribution transformers is three-phase 220 V; electrical protection elements (4) arranged interconnected between the step-up transformer (3) and the electrical connection elements (5) protecting the on-board charger (2), the step-up transformer (3) and the electrical connection elements (5) of the low-voltage electrical power distribution network; and electrical connection elements (5) arranged between the electrical protection elements (4) and the low-voltage electrical power distribution network.

The electrical connection elements (5) comprise a flexible tetrapolar cable (5A) arranged to interconnect the step-up transformer (3) by means of the electrical protection elements (4) to the low-voltage electrical power distribution network by means of the connectors (5B) when there is a need to recharge electrically powered automotive vehicles via the low-voltage electrical power distribution network itself; connectors (5B) arranged between the flexible tetrapolar cable (5A) and the low-voltage electrical power distribution network, both in bare and multiplexed low-voltage networks based on standards, connecting the low-voltage electrical power distribution network to the step-up transformer (3) and the on-board charger (2); an on-board retractable reel (5C) arranged adjacent to the electrical protection elements (4) and step-up transformer (3), in the passage of the lower part of the flexible tetrapolar cable (5A); and a support reel (5D) arranged on the power pole adjacent to the power distribution network to be interconnected to support the upper part of the flexible four-core cable (5A).

The electric truck with on-board charger for power distribution network maintenance services, according to the application needs, is comprised of an electric truck with on-board charger (1) in which the connectors (5B) are of the protected clamp type for use in low and medium voltage networks.

The procedures for a safe and efficient connection of the electric propulsion automotive cargo vehicle—electric truck to the low voltage power distribution network for carrying out opportunity recharges include, in summary, the following steps: park the electric propulsion automotive cargo vehicle near the power pole where the connection to the low voltage power distribution network will be made; perform local signaling and mechanical isolation of the electric truck; leave the circuit breaker of the flexible four-core cable supplying the low voltage power distribution network turned off; release this flexible four-core cable supplying the low voltage network via the on-board retractable reel (5C) in the quantity necessary to make the connection to the low voltage network; place the flexible four-core cable (5A) inside the corrugated mechanical protection; secure the flexible four-core cable (5A) with the connectors (5B) in the aerial basket; raise the aerial basket to the point where the connection to the low-voltage power distribution network will be made; install the rigid and rubber covers on the power cables of the power distribution network on the side opposite to the connection and then on the connection side; place this power cable on the support reel (5D) and install it at the highest point of the AS4 structure, tying it to prevent it from slipping; make the connections to the low-voltage power distribution network; once the connection is complete, return to the ground; and turn on the power cable circuit breaker to power the battery charging system of the electric propulsion vehicle.

A similar reverse procedure is applied to remove the connection of the electric propulsion vehicle—electric truck to the low-voltage power distribution network.

It should be noted that, in the specific case of the electric truck tested—model T7 of the BYD brand, this includes a high voltage system mounted on the chassis structure responsible for providing enough energy to drive the traction motor and power some low voltage electrical components of the electric truck, as well as the on-board battery is made of lithium iron phosphate with a capacity of 174 kWh and a voltage of 512V, in order to provide energy in DC standard, which is transformed into AC by the motor controller to power the traction motor.

In the same specific case of the electric truck tested—model T7 of the BYD brand, the on-board charger (2) has a maximum power of 40 kW and the battery of the electric truck has a charging capacity of 174 kWh, so the charging rate (considering the maximum power) is 40 kW/h. In this way, this electric truck recharges its battery completely (0% to 100%) in approximately four hours, when a power of 40 kW is available at the low voltage of the distribution transformer of the electricity distribution network, which is the same time required for recharging at fixed charging stations.

Considering that the truck's autonomy is approximately 200 km for the full battery charge (174 kW), it can be estimated, without taking into account factors related to the driver's drivability, that for each hour of opportunity recharging with a maximum power of 40 kW, a range of 50 km is obtained for the displacement of the electric truck subject to the test.

In this same specific case of the tested electric truck—model T7 of the BYD brand, with regard to the connection of the flexible tetrapolar cable (5A) to the low voltage electricity distribution network, when there is a need to recharge electric propulsion automotive vehicles using the low voltage electricity distribution network itself, there is a connector (5B) with pressure closure installed on the multiplexed red cable and on the lower phase of the bare network, while the connector (5B) with screw closure was installed on the gray conductor (5B) of the multiplexed network and on the upper bare conductor (5B).

Therefore, it is important to emphasize that the availability of electrical power in the low-voltage electrical power distribution networks required for the opportunity recharges of electric-powered freight vehicles was exhaustively analyzed and tested using a proprietary methodology based on several computer simulations of the electrical system.

Additionally, it is important to emphasize that opportunity recharges carried out directly from the electrical power distribution network cannot be carried out simultaneously with maintenance operations on the electrical power distribution network. Maintenance of the electrical power distribution network must first be carried out and only then the opportunity to recharge can be started, or vice versa.

This restriction is due to the fact that the battery system on board electric-powered freight vehicles does not allow simultaneous electrical charging and discharging procedures, and can only be recharged, for the integrity and safety of electric-powered freight vehicles and operators, when the high-voltage systems are turned off.

Although an execution method is exemplified in which, for the sake of economy and suitability of tests, the on-board charger (2) and the step-up transformer (3) are described with certain powers and other structural and electrical characteristics, it would also be understood by a person skilled in the art that such components, the on-board charger (2) and the step-up transformer (3), are manufactured and integrated with other powers and other pertinent structural and electrical characteristics, without departing from the present inventive scope.

Thus, the electric truck with on-board charger for power distribution network maintenance services presents itself as a case with high and precise operability fully on-board electric-powered cargo vehicles, so as to allow its components to be accommodated, fitted and fixed to the electric-powered cargo vehicles, as well as direct power supply by connection to low-voltage power distribution networks. In this line, the electric truck with on-board charger

(1) was designed to serve any services, primarily those related to the maintenance of widely known electric power distribution networks.

The electric truck with on-board charger for power distribution network maintenance services, as its components are fully integrated with each other, nothing comes loose and nothing can break or bend, achieves a high level of performance and efficiency, combined with high durability and absolute safety. Once fully integrated with each other and with the electric-powered cargo vehicle, the components are secured and cohesive, thus preventing them from coming loose on their own when in use, leaving the assembly fully available for routine procedures for recharging electric-powered cargo vehicles on the low-voltage power distribution network itself. In this way, the electric truck with on-board charger (1) can be used without any concerns, especially regarding the durability and safety of its components, in addition to the safety of users.

Based on everything that has been stated, this is an electric-powered cargo vehicle that will be well received by electric power concessionaires and similar companies in general, since the electric truck with on-board charger for maintenance services of the power distribution network has numerous advantages, such as: great safety, reliability and agility in application; great efficiency and performance in its application due to its general design; high comfort, convenience and safety for users; extremely high resistance and general durability, combined with low or no wear and tear on the assembly as a whole; totally affordable costs, which allows for an excellent cost/benefit ratio; practical and safe use by any user; large range; very low and practical general maintenance; perfect and direct adaptation to the most diverse types of electric-powered cargo vehicles and low-voltage power distribution networks; high operational precision; fully compatible weight and general dimensions; high operational ergonomics; and the certainty of having an electric truck with on-board charger (1) that fully complies with current legislation and standards and the basic conditions necessary for its application.

All these attributes allow the electric truck with on-board charger for power distribution network maintenance services to be classified as a totally versatile, efficient, practical and safe means for routine procedures of opportunely recharging a wide range of electrically powered cargo vehicles directly from the most diverse types of low-voltage power distribution networks, regardless of the general characteristics that they may present, however, not being limited at any time to the representations described herein, and must be understood in its broad scope of claims, that is, not being limited to the specific form revealed, and that other forms are understood as fully included within the scope claimed.

1-3. (canceled)

4. An electric truck with an on-board charger for power distribution network maintenance services, comprising:
the electric truck with an on-board charger, the on-board charger having its own characteristics, and incorporating an electronic-type structure interconnected and arranged on-board a body of the electric truck,
the on-board charger interconnected to a battery bank of the electric truck, fully or partially recharging the electric truck with the on-board charger directly on a low-voltage power distribution network;
a step-up transformer arranged interconnected to the on-board charger adapting a voltage level required for the on-board charger, in which a secondary of distribution transformers is three-phase 220V; and
electrical protection elements arranged interconnected between the step-up transformer and the electrical connection elements protecting the on-board charger, the step-up transformer and the electrical connection elements being of the low-voltage electrical power distribution network,
wherein the electrical connection elements are arranged between the electrical protection elements and the low-voltage electrical power distribution network.

5. The electric truck according to claim 4, wherein the on-board charger further includes two guns, a supply voltage at 380 Vac, at a frequency of 60 Hz, a nominal current at 63 A, a nominal recharging power of 40 kW, and a European CCS charger standard,
wherein the step-up transformer consists of a dry transformer with three phases, a primary voltage at 220V, a secondary voltage at 380V and at a power of 50KVA,
wherein the electrical connection elements consist of a flexible tetrapolar cable arranged to interconnect the step-up transformer via the electrical protection elements to the low-voltage electrical power distribution network via the connectors when recharging the electric truck by the low-voltage electrical power distribution network,
wherein connectors are arranged between the flexible tetrapolar cable and the low-voltage electricity electrical power distribution network, in bare and multiplexed low-voltage networks based on standards, connecting the low-voltage electricity distribution network to the step-up transformer and the on-board charger;
further including an on-board retractable reel arranged adjacent to the electrical protection elements and the step-up transformer, in a passage of a lower part of the flexible tetrapolar cable and a support reel arranged on an electricity pole adjacent to the low-voltage electricity distribution network to be interconnected in a support of an upper part of the flexible tetrapolar cable.

6. The electric truck according to claim 4, wherein the connectors are of a protected clamp type for use in low and medium voltage networks and a connector with pressure closure.

7. The electric truck of claim 6, wherein the protected clamp is a pressure closure protected clamp.

8. The electric truck according to claim 5, wherein the connectors are of a protected clamp type for use in low and medium voltage networks and a connector with pressure closure.

9. The electric truck of claim 8, wherein the protected clamp is a pressure closure protected clamp.
